(19) United States
(12) Patent Application Publication
(10) Pub. No.: US 2020/0285449 A1
(43) Pub. Date: Sep. 10, 2020

(54) VISUAL PROGRAMMING ENVIRONMENT

(71) Applicant: Veritone, Inc., Costa Mesa, CA (US)

(72) Inventor: Andrew McIntosh, Costa Mesa, CA (US)

(21) Appl. No.: 16/393,588

(22) Filed: Apr. 24, 2019

Related U.S. Application Data
(63) Continuation-in-part of application No. 16/294,781, filed on Mar. 6, 2019.

(51) Int. Cl. G06F 8/34; G06N 3/04; G06K 9/62; G06K 9/00

(52) U.S. Cl. CPC G06F 8/34; G06K 9/00718; G06K 9/6267; G06N 3/0454

(57) ABSTRACT

Provided herein are embodiments of systems and methods for developing a neural network-based application using a visual programming development (VPD) environment. One of the methods includes providing a user interface portal hosted within the VPD environment. The user interface portal includes: a data ingestion node configured to ingest and send an input file to a data preprocessor for preprocessing; a classification node configured to send one or more portions of the input file to one or more neural networks for classification based at least on one or more classification objectives defined by a user; and an output node configured to receive one or more classification results from the one or more neural networks.

### CROSS-REFERENCE TO RELATED APPLICATIONS

This present application is a continuation-in-part of U.S. patent application Ser. No. 16/294,781, filed Mar. 6, 2019, the disclosure of which is incorporated herein by reference in its entirety for all purposes.

### BACKGROUND

Visual programming has been around for many years and is becoming a go to tool for casual programmers (or even non-programmers) to quickly develop software applications. Visual programming is a tool that allows casual programmer to program and create various software applications such as IoTs (Internet of things) applications with just basic knowledge of computer programming. In some cases, visual programming can allow engineers to create basic applications without any prior programming experiences. Visual programming eliminates the requirement to have a deep knowledge of programming languages. It enables engineers, who are typically are not software developers, to develop and test software applications to test run their products.

Traditional code-based programing methods for software development, even for simple application, can be very time consuming and requires extensive programming knowledge. With visual programming drag and drop interface, non-programmers such as engineers, scientists, and marketing personnel can develop simple applications in a short amount of time with very little coding.

### SUMMARY

Provided herein are embodiments of systems and methods for developing a neural network-based application using a visual programming development (VPD) environment. One of the methods includes providing a user interface portal hosted within the VPD environment. The user interface portal includes: a data ingestion node configured to ingest and send an input file to a data preprocessor for preprocessing; a classification node configured to send one or more portions of the input file to one or more neural networks for classification based at least on one or more classification objectives defined by a user; and an output node configured to receive one or more classification results from the one or more neural networks. The input file includes one or more of audio and video data. The input file can be an audio file, a video file, or a multimedia file.

The classification node is configured to enable a user to select one or more classification tasks to perform on the input file. The one or more classification tasks can include tasks such as transcription, objection detection, object recognition, facial detection, facial recognition, object redaction, and facial redaction. The classification node can also be configured to automatically perform a classification task on data of the input file based on a data type of the input media file. For example, if the input file is a video file, the classification node can perform image classification, object detection and recognition, and or facial detection and recognition.

The user interface portal further includes an orchestration node configured to select, using an orchestration neural network, a first neural network from the one or more neural networks to classify a first portion of the input file based at least on one or more characteristics of the first portion and an attribute of the first neural network. The one or more characteristics of the first portion of the input file and the attribute of the first neural network can be audio spectrogram features and a predicted word error rate (WER) of the first neural network, respectively.

The audio spectrogram features (e.g., audio features) can be extracted from one or more layers of an audio classification neural network. The audio classification neural network can be a pre-trained audio classification neural network such as, but not limited to, deep speech or CMU-Sphinx. The audio features can be represented by weighs of nodes of one or more layers.

The one or more characteristics of the first portion of the input file and the attribute of the first neural network can also be image features and a performance score of the first neural network for the first portion of the input file, respectively. Image features can be extracted from one or more layers of an image classification neural network, which can be a pre-trained image classification neural network such as, but not limited to, VGG neural network. The image features can be represented by weighs of one or more layers of the image classification neural network.

The user interface portal can further include an orchestration node configured to cause an orchestration neural network to: select a first neural network from the one or more neural networks to classify a first portion of the input file based at least on one or more characteristics of the first portion and an attribute of the first neural network; and select a second neural network from the one or more neural networks to classify a second portion of the input file based at least on one or more characteristics of the second portion and an attribute of the second neural network.

The one or more classification objectives can be a first objective to transcribe audio data of the input file and to identify one or more objects in video data of the input file. In some embodiments, the input file must contain more than textual data. The classification node further comprises a graphical user interface (GUI) to receive one or more classification objectives from the user. The one or more classification objectives can be one or more of (but not limited to) a transcription objective, an object recognition and identification objective, a sentiment objective, and an expression objective.

The GUI can be configured to receive two or more classification objectives to perform on the input file. The GUI can be configured to allow the user to specify a pricing tier of the one or more neural networks to which the classification node can send the one or more portions of the input file for classification.

Also provided herein is a system for developing a neural network-based application using a visual programming development (VPD) environment. The system includes: a memory; and one or more processors coupled to the memory. The one or more processors are configured to: provide a user interface (UI) portal hosted within the VPD environment; provide a data ingestion node, within the UI portal, configured to ingest and send an input file to a data preprocessor for preprocessing; provide a classification node, within the UI portal, configured to send one or more portions of the input file to one or more neural networks for classification based at least on one or more classification objectives defined by a user; and provide an output node, within the UI portal, configured to receive one or more classification results from the one or more neural networks.

The one or more processors are further configured to provide an orchestration node, within the UI portal, that is configured to select (using an orchestration neural network) a first neural network from the one or more neural networks to classify a first portion of the input file based at least on one or more characteristics of the first portion and an attribute of the first neural network. The one or more characteristics of the first portion of the input file and the attribute of the first neural network comprise audio features and predicted word error rate (WER) of the first neural network, respectively. The audio features can be extracted from one or more layers of an audio classification neural network.

The one or more characteristics of the first portion of the input file and the attribute of the first neural network can be image features and a performance score of the first neural network for the first portion of the input file, respectively. The one or more classification objectives comprise a first objective to transcribe audio data of the input file and a second objective to classify one or more objects in video data of the input file.

Also provided is a method comprising: providing a user interface portal hosted within the VPD environment, the user interface portal comprises: a data ingestion node configured to ingest and send an input multimedia file to a data preprocessor for preprocessing; a classification node configured to automatically send the audio data of the input multimedia file to a first group of one or more neural networks for classification and the video data of the input multimedia file to a second group of one or more neural networks for classification; and an output node configured to receive classification results from the first and second groups of neural networks.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 illustrates VPD environment in accordance with some embodiments of the present disclosure.

FIGS. 2-5 illustrate example workflows in accordance with some embodiments of the present disclosure.

FIG. 6 illustrates a block diagram of a VPD system in accordance with some embodiments of the present disclosure.

FIG. 7 illustrates a block diagram of a computer system configured to implement the VPD environment in accordance with some embodiments of the present disclosure.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The disclosed visual programing development environment (“VPD environment”) enables developers to accelerate and introduce intelligence to their application workflow without requiring extensive machine learning development skills. The VPD environment allows developers to seamlessly integrate and automate intelligence to their application processes by allowing developers to (for example) drag and drop cognitively-enabled (e.g., AI-enabled (artificial intelligence)) node(s) to their application workflow. This allows their application to implement AI processes without much coding or extensive understanding of machine learning algorithms and models.

Machine learning is an algorithm that is able to learn from data. For example, a computer program is said to learn from experience ‘E’ with respect to some class of tasks ‘T’ and performance measure ‘P’, if its performance at tasks in ‘T’, as measured by ‘P’, improves with experience ‘E’. Examples of machine learning algorithm may include, but not limited to, deep learning neural networks; feedforward neural networks, convolutional neural networks, and generative adversarial neural networks. A node can be a visual representation in the VPD environment of a software module having instructions and algorithms to cause one or more processors to perform the functions as described or specified by each node.

The VPD environment includes a flow designer that leverages visual programming tools to empower developers to construct cognitively-enabled business logic and workflows with drag-and-drop cognitive API (application programming interface) service via a simple user-interface (UI) requiring low to no coding by the user. A cognitive API services can include, but not limited to, API calls to one or more of a transcription neural network, a sentiment neural network, a topical analysis neural network, an object detection and recognition neural network, a facial detection and recognition neural network, and a facial or object redaction neural network. This list is not exhaustive as other classification neural networks (e.g., animal, color classification) can be part of an ecosystem of neural networks that is available to the cognitive API service.

In the VPD environment, the drag and drop cognitive API services are represented as workflow nodes. Each node can encapsulate executable code to perform a specific function (e.g., request services of a classification neural network, pre-process data for ingestion by a neural network). The workflow nodes can be a generic collection or palette of nodes (e.g., function, switch, change, report by exception, and email output) and can also include a proprietary palette with nodes configured to perform specific cognitive-enabled function such as, but not limited to, neural network transcription orchestration, inter-class neural network orchestration, transcription, redaction, facial detection and recognition, and object detection and recognition.

Working in the VPD environment can involve three primary stages: design, deploy, and assess. In the design stage, a user can define a problem she is trying to solve or a tangible goal she wants to achieve. Once defined, the user can sketch out the process and associated variables using the flow designer within the VPD environment. The flow designer allows the user to create an entire workflow by framing the design process as a data path-issue. In other words, the design of an application workflow is essentially completed once the path on which the data travel is clearly defined. The path defines the processes and/or functions to be applied to the data. Some questions to consider during the data path construction are: where will the data go and what do you need to do with the data to obtain the desired output state? With the data path defined, the user can select appropriate nodes that are specifically designed to apply a process and/or function on the data as required by each respective node on the data path. For example, the user can input the data to a data preprocessing node for data ingestion and pre-processing, the outputs of which can then be used as inputs to an AI-enabled transcription node.

Once the design stage is completed, the workflow can be deployed using the VPD environment. A deployed workflow can ingest and process data in real-time as specified by the nodes. The last of the three stages is to assess the data and/or tasks of the deployed workflow. The assessment of the returned data and/or results of the tasks implemented by nodes on the data path allows the user to debug, adjust, and react to the results of the application workflow as needed. This enables the development, testing, and full deployment of applications in an efficient and cost-effective manner. When developing AI-enabled applications with the VPD environment, the time and cost saving is significant as traditional application development methods require extensive understanding of AI algorithms and models, in addition to expert coding skills. The VPD environment enables non-data scientists to develop and deploy AI-enabled applications with simple and easy to implement drag and drop functionalities.

Other advantages of the VPD environment include visual AI, rapid solution prototyping, seamless collaboration, real-time debugging, fast-to-market system integration, and future-proof design with AI-enabled workflow. Visual AI can leverage prescribed events to trigger automated AI-enabled workflow that can replace time-consuming processes of developing and deploying AI (e.g., machine learning) manually. The VPD environment enables rapid solution prototyping by enabling developers to build end-to-end intelligent solutions or to augment existing application with AI-enabled workflow within hours, not months. This is made possible with AI-enabled nodes that are configured to perform various tasks such as, but not limited to, audio, image, object, and video classifications. The AI-enabled nodes can include pre-trained neural network models to perform a variety of classifications. The AI-enabled nodes can also request (e.g., make API calls) to remotely located neural networks to perform the variety of classification tasks.

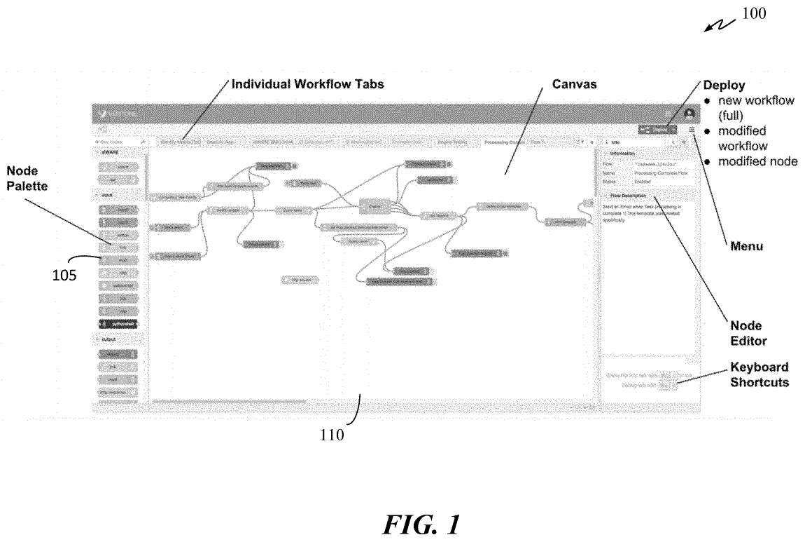

FIG. 1 illustrates a VPD environment (or portal) 100 in accordance with some embodiments of the disclosure. Portal 100 can be a stand-alone application or can run on top of or within another application such as an Internet browser (e.g., Mozilla Firefox and Microsoft Edge). Portal 100 can include a node palette 105 that displays available nodes such as the input and output nodes categories, each of which includes a wide collection of nodes. Node palette 105 can include traditional nodes such as function, switch, change, report by exception, and email output.

Node palette 105 can also include proprietary nodes (not shown) such as, but not limited to, AI-enabled nodes, data NN (neural network) pre-processing node, and NN orchestration node (now shown). AI-enabled nodes can include transcription node, object detection and/or recognition node, facial detection and/or recognition node, text redaction node, facial (video) redaction node. Propriety nodes can also be displayed as an independent palette, separate from node palette 105.

Portal 100 also include a canvas 110 where each node of node palette 105 can be dragged and dropped to design a workflow for an application. Nodes are connected to control the flow of data between nodes using connectors 115. Each node can be individually configured by evoking the node editor window, which can be a popup window or be aligned to the right side of portal 100. The node editor window displays characteristics that can be unique to a particular node. One or more of the node characteristics can be defined, changed, and/or deleted by the user. The node editor can also include a coding window where the user can add, modify, and/or delete codes/scripts of the node.

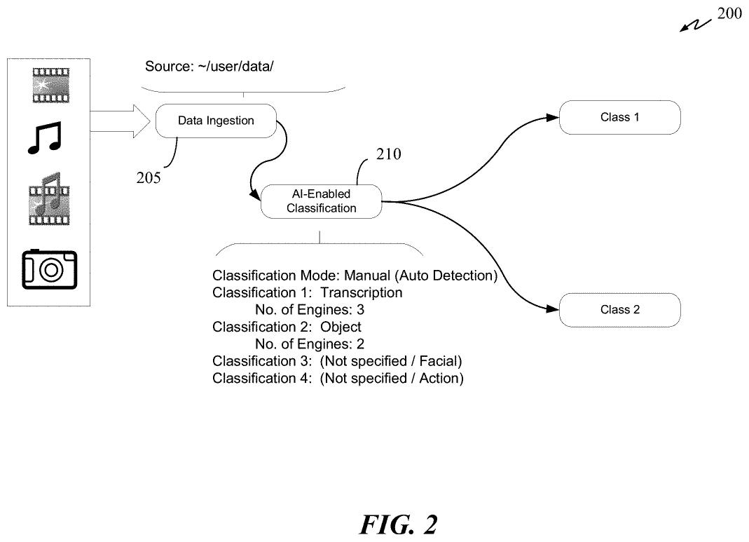

FIG. 2 illustrates an example AI-enabled workflow 200, generated using portal 100, in accordance with some embodiments of the disclosure. Workflow 200 can include a data ingestion node 205 configured to ingest data such as audio, image, video, and multimedia files. Node 205 can automatically detect the file type (e.g., image, video, audio) and process the data appropriately. Alternative, the user can define the file type manually using the node editor. The user can also define the source location of the data in the node editor. The data ingestion node can also include a data-processing functions which the user can configure using the node editor. For example, given a multimedia input file, the user can specify to extract only the audio or video portion of the multimedia file. The user can also specify to extract only the metadata of the multimedia file, for example. Alternatively, the data processing functions can be implemented using a separate data pre-processing node.

The data pre-processing functions can be a part of the data ingestion node 205 and/or a data pre-processing node (not shown) of palette 105. The data pre-processing functions can include, but not limited to, audio feature extraction, image feature extraction, and data vectors and/or matrices transformation. In other words, node 205 is configured to transform the input data (e.g., audio or image) into vectors or matrices representation for use as inputs of a neural network.

Node 205 can send the input file to a data preprocessor (not shown), which can reside locally or remotely. The data preprocessor can be configured to perform the data pre-preprocessing functions as described above. For example, the data preprocessor can ingest an audio file and transforms it to vectors or matrices representation, which can readily be inputted into a neural network for classification (e.g., audio-to-text classification). The data preprocessor can also extract features of the input file using feature extraction neural networks such as but not limited to an audio classification neural network, an image classification neural network, and a topic extraction neural network. Audio features can be extracted from one or more layers of the audio classification (e.g., audio spectrogram to text) neural network. Image features can be extracted from one or more layers of the image classification neural network. Topic extraction can be done based on analysis of the metadata of the input file and/or the transcription results from the audio classification neural network.

AI-enabled node 210 can be drawn on the canvas of portal 100 to receive outputs of data ingestion node 205. AI-enabled node 210 can be configured by the user to perform auto detect the type of input data and perform classification automatically. For example, node 210 can recognize that the input file is a multimedia file having audio and video data. In response to this detection, node 210 can automatically transcribe the audio data and perform image, object, and/or facial detection and recognition. In some embodiments, the user can set the classification mode to manual and can configure node 210 to classify certain data only. For example, the user can instruct node 210 to perform transcription and/or object recognition. Node 210 can also be configured to enable the user to specific the number of engines (e.g., neural network) to use for each classification task. For example, the user can specify node 210 to use three neural networks for the transcription task and two neural networks for the object detection and recognition tasks. In some embodiments, when two or more engines are specified, the neural network orchestration feature is automatically enabled. Neural network (NN) orchestration can be a function of an orchestration node (not shown), which will be described below. However, NN orchestration is a process where a portion of the input media file is assigned to a specific neural network for classification based at least on the characteristics of the portion of the input media file and one or more attributes of the assigned neural network such as WER (word error rate) or confidence score. The characteristic of the input media file can be audio feature, image feature, detected topic, detected sentiment, etc. The NN orchestration process can also include orchestration based on interclass data. For example, the selection of one or more transcription neural networks to classify a certain portion of the audio data (of the input media file) can depend on classification results of a different data class (e.g., image, object, facial, or topic classification) of another data portion of the input media that corresponds with the audio portion. For instance, in the multimedia file, each video portion has a corresponding audio and metadata portion. In this example, the selection of a transcription neural network to transcribe the audio portion can depend on the classification of the corresponding video portion of the multimedia file.

Outputs of classification node 210 can be inputted into other nodes for further processing and/or action in response to the classification results at nodes 215 and 220.

In an exemplary workflow, the input file can be a multimedia file having audio and video data. The source of the input file can be specified by evoking the node editor of data ingestion node 205, which can automatically detect the file type and determine the types of available data (e.g., audio, video, metadata). Data ingestion node 205 can also pre-process the audio or image data and transform the data suitable for the neural network. Next, classification node 210 can classify the data from node 205 automatically or by using the configuration set by the user. For example, the user may configure node 210 to only transcribe the audio data and ignore other classes of data such as images and metadata.

The NN orchestration process can be integrated with AI-enabled classification node 210. The NN orchestration process can also be implemented as a separate orchestration node.

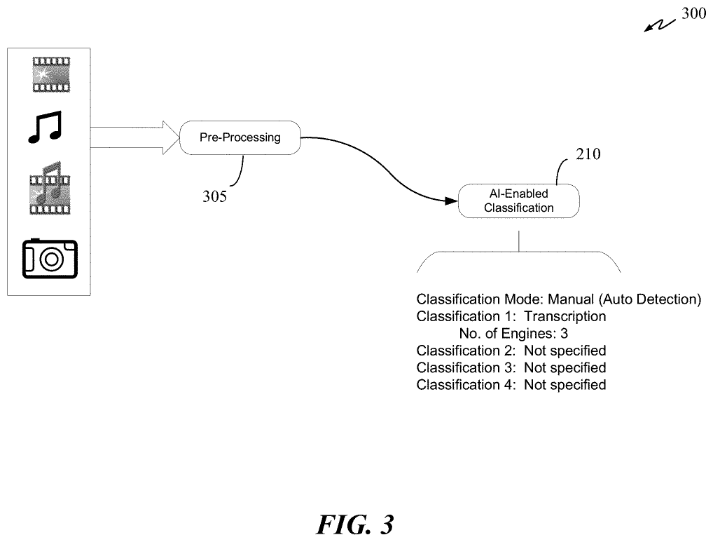

FIG. 3 illustrates an AI-enabled workflow 300 in accordance with some embodiments of the present disclosure. In workflow 300, the function of data ingestion node 205 can be integrated with pre-processing node 305, which can be further configured to automatically process the input file to transform each available data type (audio, image, metadata, text) to appropriate vectors and/or matrices representation. Pre-processing node 305 is also configured to segment the input file into a plurality of portion. In some embodiments, pre-processing node 305 can also extract features of the input file. For an audio file, pre-processing node 305 can extract audio features of each audio portion (after the segmentation process). Pre-processor 305 can also extract audio features for the entire file. This can be done before transforming the original data into the vectors space.

Node 305 can segment the audio file or audio data of the input file into a plurality of audio portions having a certain time duration (e.g., 1, 5 seconds). Node 305 can also segment the input file by topic classification of the audio file and scene classification of the image data. The segmented portions (e.g., audio portions, image portions) can be sent to the NN orchestration node embedded within AI-enabled classification node 210 for orchestration. The orchestration process uses a trained orchestration neural network that predicts the best neural network to classify a portion of an audio file based on the audio features of the audio portion. For image or object recognition, the trained orchestration neural network predicts the best image or object classification neural network based on image features extracted from the image to be classified.

As shown in workflow 300, AI-enabled node 210 is set to the manual classification mode. Here, the user has configured node 210 to transcribe the audio data from pre-processor 305 using three engines. This means that the NN orchestration node will orchestrate three engines to decide which engine would be best to transcribe each portion of the audio data.

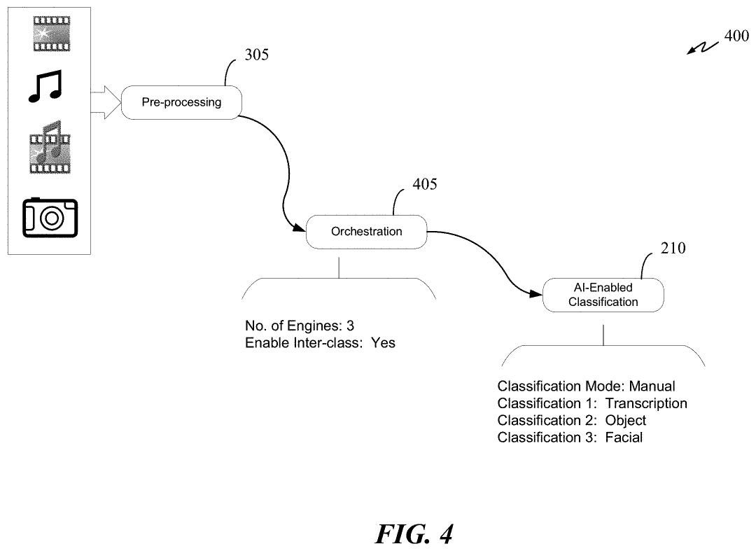

It should be noted that the NN orchestration process/functions can be integrated in pre-processing 305 and/or AI-enabled node 210. Alternatively, the NN orchestration process can be implemented as an independent node (see FIG. 4).

FIG. 4 illustrates a workflow 400 in accordance with some embodiments of the present disclosure. Workflow 400 include AI-enabled node 210, pre-processing node 305, and orchestration node 405. Orchestration node 405 is configured to perform the functions of the NN orchestration process as described in workflows 200 and 300. In some embodiments, the user can specify the number of engines to use in the orchestration process. The user can also specify whether to do interclass NN orchestration. Orchestration node 405 can cause the orchestration process to be implemented locally or remotely using a remotely located neural network.

The NN orchestration (as implemented by node 405) is an efficient way to determine which engine (e.g., neural network), from an ecosystem of engines, would perform the best for the type of input data. In general, the selection of an AI engine that would yield the best transcription accuracy can be a daunting task given the dynamic of an audio file and the number of available transcription engines. A trial and error approach for selecting an engine (e.g., AI engine, neural network engine) to transcribe the audio file can be time consuming, cost prohibitive, and inaccurate. Veritone's NN orchestration process enables a smart, orchestrated, and accurate approach to engine selection that yields a highly accurate classification transcription of the audio file. Additionally, where one or more segments of the audio file that have persistently low transcription accuracy, the NN orchestration process can use metadata, image(s), and/or video associated with the audio file to determine an alternative transcription engine(s) that can better transcribe the audio segment.

The NN orchestration node 405 can perform interclass (e.g., audio and video data) NN orchestration to obtain better transcription results by using a classification result obtained by another engine of a different class (e.g., object classification, color classification, gender classification, facial recognition) as an input for selecting an alternative transcription engine. This also works the other way around. Orchestration node 405 can also use a classification result obtained by a transcription engine to help select the best candidate engine for other classification tasks such as, but not limited to, facial recognition, voice/speaker recognition, object recognition, and color recognition. For example, an engine may have problem correctly classifying an image of a hummingbird. However, orchestration node 405 with interclass NN orchestration can analyze the audio track associate with the image and determine that the speaker is talking about a hummingbird. Using this information, orchestration node 405 can select an engine specialized in classifying animal or bird images to better or correctly re-classify the image as a hummingbird.

In another example, a transcribed portion of an audio segment, returned by a transcription engine, “the Maria” can appear to be a proper pronoun. The transcribed portion “the Maria” can have a low to medium confidence of accuracy. In some embodiments, orchestration node 405 can be configured to automatically reanalyze the audio segment associated with the transcribed portion that have a confidence of accuracy below a certain accuracy threshold (e.g., 60%). Orchestration node 405 can reanalyze the low confidence audio segment (i.e., the audio segment having the transcribed portion with a low confidence of accuracy) using a different engine that was used in the previous cycle. Orchestration node 405 can select a different engine based on other data associated with the audio segment such as the image/video portion of a multimedia—with the audio segment being the audio portion of the multimedia. Other data associated with the audio segment can also be, but not limited to, metadata. With the “the Maria” example, the NN orchestration process can classify the image associated with the audio segment having the “the Maria” transcript using an image classification engine. The image classification result can show, with a high level of confidence, that the image is of the soccer player “Di Maria.” Using this image classification result, orchestration node 405 can reclassify the audio segment as “Di Maria.” This can be done by replacing the original transcription (the Maria) with metadata of the image (e.g., tag data). In some embodiments, the NN orchestration process can select a different classification engine (typically a specialized engine) based on the image classification result. In this case, the NN orchestration process can select a specialized sports or soccer engine to re-classify the audio segment, which can have a much higher probability of transcribing the audio segment correctly as “Di Maria” rather than “the Maria.”

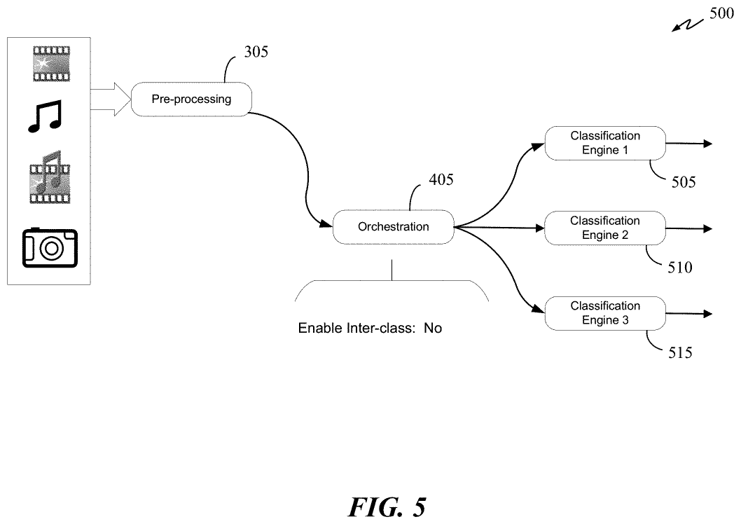

FIG. 5 illustrates a workflow 500 in accordance with some embodiments of the present disclosure. Workflow 500 is similar 400 except that in workflow 500 AI-enabled node 210 is replaced by individual classification nodes 1-3. Each of these nodes is configured to perform a single classification task such as object recognition, facial recognition, or audio transcription. In workflow 500, orchestration node 405 is set to orchestrate between the three selected engines, which are represented by nodes 505, 510, and 515. In this workflow, the user can specify the exact engines to orchestrate.

The outputs of nodes 505, 510, and 515 can also be fed back to node 405 so that node 405 can orchestrate based on the outputs of those nodes. In other words, node 405 can collect results from nodes 505, 510, and 515 to generate a combined outputs.

### System Architecture

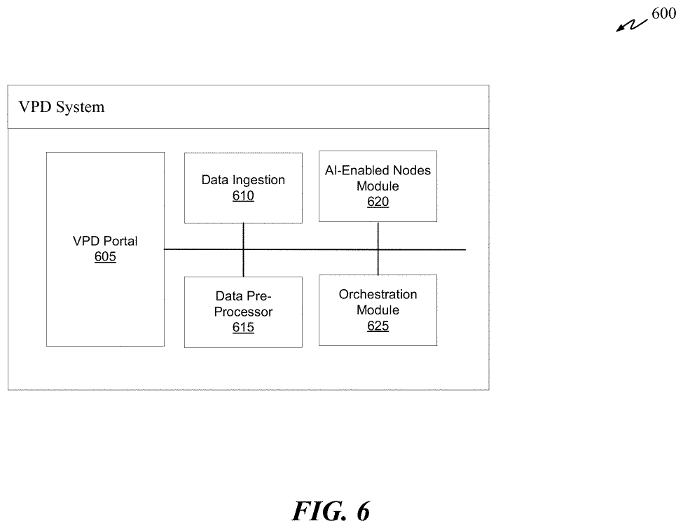

FIG. 6 illustrates a VPD system 600 in accordance with some embodiments of the present disclosure. VPD system 600 includes VPD portal module 605, data ingestion module 610, data preprocessor (module) 615, AI-enabled module 620, and orchestration module 625. VPD portal module 605 contains instructions and algorithms to cause one or more processors to render VPD portal 100 (see FIG. 1) on a display. Module 605 also contains instructions and algorithms to cause one or more processors to perform the functions and features as described in FIG. 1.

Data ingestion module 610 contains instructions and algorithms to cause one or more processors to receive, download, fetch, and/or crawl for data as specified the user. Data ingestion module 610 also contains instructions and algorithms to cause one or more processors to perform the functions and features of data ingestion node 205 of FIG. 2.

Data preprocessor 615 contains instructions and algorithms to cause one or more processors to preprocess the input data as described in FIG. 2. For example, data preprocessor 615 contains instructions and algorithms to cause one or more processors to segment the input data into a plurality of segments and/or to transform the data into a neural network ready data format such as vectors and matrices.

AI-enabled nodes module 620 contains instructions and algorithms to cause one or more processors to perform and functions and features of AI-enabled node 210 as described in FIGS. 2, 3, 4, and 5. AI-enabled nodes module 620 can also contain a collection of pre-trained neural networks to perform classification various data such as audio data, image data, text data, and metadata. For example, AI-enabled nodes can perform a local or remote API call to pre-trained neural networks to perform speech-to-text classification, object detection and recognition, facial detection and recognition, topic classification, etc.

Orchestration module 625 contains instructions and algorithms to cause one or more processors to perform and functions and features of AI-enabled node 205 orchestration related functions and orchestration node 405 as described in FIGS. 2, 4, and 5.

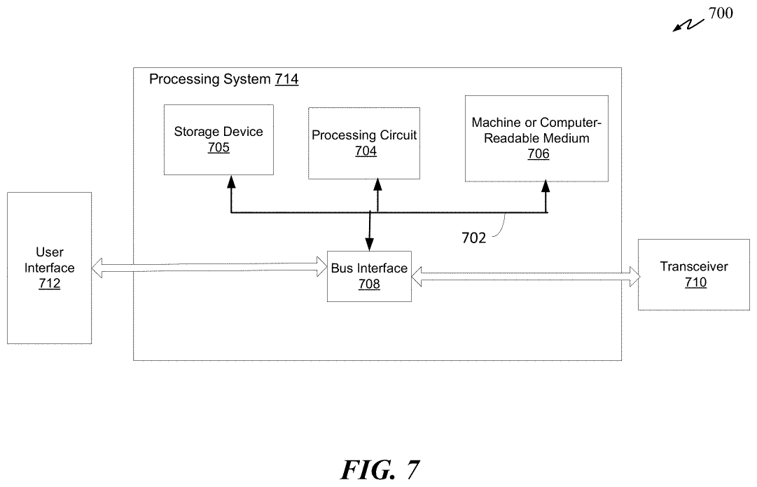

FIG. 7 illustrates an exemplary overall system or apparatus 700 in which workflow 100, 200, 300 and 400 can be implemented. In accordance with various aspects of the disclosure, an element, or any portion of an element, or any combination of elements may be implemented with a processing system 714 that includes one or more processing circuits 704. Processing circuits 704 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionalities described throughout this disclosure. That is, the processing circuit 704 may be used to implement any one or more of the functions and features as described above and illustrated in FIGS. 1, 2, 3, 4, and 5.

In the example of FIG. 7, the processing system 714 may be implemented with a bus architecture, represented generally by the bus 702. The bus 702 may include any number of interconnecting buses and bridges depending on the specific application of the processing system 714 and the overall design constraints. The bus 702 may link various circuits including one or more processing circuits (represented generally by the processing circuit 704), the storage device 705, and a machine-readable, processor-readable, processing circuit-readable or computer-readable media (represented generally by a non-transitory machine-readable medium 709). The bus 702 may also link various other circuits such as timing sources, peripherals, voltage regulators, and power management circuits, which are well known in the art, and therefore, will not be described any further. The bus interface 708 may provide an interface between bus 702 and a transceiver 713. The transceiver 710 may provide a means for communicating with various other apparatus over a transmission medium. Depending upon the nature of the apparatus, a user interface 712 (e.g., keypad, display, speaker, microphone, touchscreen, motion sensor) may also be provided.

The processing circuit 704 may be responsible for managing the bus 702 and for general processing, including the execution of software stored on the machine-readable medium 709. The software, when executed by processing circuit 704, causes processing system 714 to perform the various functions described herein for any particular apparatus. Machine-readable medium 709 may also be used for storing data that is manipulated by processing circuit 704 when executing software.

One or more processing circuits 704 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

For example, instructions (e.g., codes) stored in the non-transitory computer readable memory, when executed, may cause the processors to: select, using a trained layer selection neural network, a plurality of layers from an ecosystem of pre-trained neural networks based on one or more attributes of the input file; construct, in real-time, a new neural network using the plurality of layers selected from one or more neural networks in the ecosystem, wherein the new neural network is fully-layered, and the selected plurality of layers are selected from one or more pre-trained neural network; and classify the input file using the new fully-layered neural network.

The software may reside on machine-readable medium 709. The machine-readable medium 709 may be a non-transitory machine-readable medium. A non-transitory processing circuit-readable, machine-readable or computer-readable medium includes, by way of example, a magnetic storage device (e.g., solid state drive, hard disk, floppy disk, magnetic strip), an optical disk (e.g., digital versatile disc (DVD), Blu-Ray disc), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium”, and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium”, and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 709 may reside in the processing system 714, external to the processing system 714, or distributed across multiple entities including the processing system 714. The machine-readable medium 709 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system.

One or more of the components, processes, features, and/or functions illustrated in the figures may be rearranged and/or combined into a single component, block, feature or function or embodied in several components, steps, or functions. Additional elements, components, processes, and/or functions may also be added without departing from the disclosure. The apparatus, devices, and/or components illustrated in the Figures may be configured to perform one or more of the methods, features, or processes described in the Figures. The algorithms described herein may also be efficiently implemented in software and/or embedded in hardware.

Note that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

### CONCLUSION

The enablements described above are considered novel over the prior art and are considered critical to the operation of at least one aspect of the disclosure and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

1. A method for developing a neural network-based application using a visual programming development (VPD) environment, the method comprising:
providing a user interface portal hosted within the VPD environment, the user interface portal comprises:
a data ingestion node configured to ingest and send an input file to a data preprocessor for preprocessing, wherein the input file includes one or more of audio and video data;
a classification node configured to send one or more portions of the input file to one or more neural networks for classification based at least on one or more classification objectives defined by a user; and
an output node configured to receive one or more classification results from the one or more neural networks.

2. The method of claim 1, wherein the classification node is configured to enable a user to select one or more classification tasks to perform on the input file.

3. The method of claim 2, wherein the one or more classification tasks comprise transcription, objection detection, object recognition, facial detection, facial recognition, object redaction, and facial redaction.

4. The method of claim 2, wherein the classification node is configured to automatically perform a classification task on data of the input file based on a data type of the input media file.

5. The method of claim 1, wherein the user interface portal further comprises an orchestration node configured to select, using an orchestration neural network, a first neural network from the one or more neural networks to classify a first portion of the input file based at least on one or more characteristics of the first portion and an attribute of the first neural network.

6. The method of claim 5, wherein the one or more characteristics of the first portion of the input file and the attribute of the first neural network comprise audio spectrogram features and a predicted word error rate (WER) of the first neural network, respectively.

7. The method of claim 6, wherein the audio spectrogram features are extracted from one or more layers of an audio classification neural network.

8. The method of claim 6, wherein the one or more characteristics of the first portion of the input file and the attribute of the first neural network comprise image features and a classification accuracy score of the first neural network for the first portion of the input file.

9. The method of claim 8, wherein the image features are extracted from one or more layers of an image classification neural network.

10. The method of claim 1, wherein the user interface portal further comprises an orchestration node configured to cause an orchestration neural network to:
select a first neural network from the one or more neural networks to classify a first portion of the input file based at least on one or more characteristics of the first portion and an attribute of the first neural network; and
select a second neural network from the one or more neural networks to classify a second portion of the input file based at least on one or more characteristics of the second portion and an attribute of the second neural network.

11. The method of claim 1, wherein the one or more classification objectives comprise a first objective to transcribe audio data of the input file and to identify one or more objects in video data of the input file.

12. The method of claim 1, wherein the input file comprises more than text data.

13. The method of claim 1, wherein the classification node further comprises a graphical user interface (GUI) to receive one or more classification objectives from the user, wherein the one or more classification objectives comprises one or more of a transcription objective, an object recognition and identification objective, and an expression objective.

14. The method of claim 13, wherein the GUI is configured to receive two or more classification objectives to perform on the input file.

15. The method of claim 13, wherein the GUI is configured to allow the user to specify a pricing tier of the one or more neural networks to which the classification node can send the one or more portions of the input file for classification.

16. A system for developing a neural network-based application using a visual programming development (VPD) environment, the system comprising:
a memory;
one or more processors coupled to the memory, the one or more processors configured to:
provide a user interface (UI) portal hosted within the VPD environment;
provide a data ingestion node, within the UI portal, configured to ingest and send an input file to a data preprocessor for preprocessing, wherein the input file includes one or more of audio and video data;
provide a classification node, within the UI portal, configured to send one or more portions of the input file to one or more neural networks for classification based at least on one or more classification objectives defined by a user; and
provide an output node, within the UI portal, configured to receive one or more classification results from the one or more neural networks.

17. The system of claim 16, wherein the one or more processors are further configured to provide an orchestration node, within the UI portal, configured to select a first neural network from the one or more neural networks, using an orchestration neural network, to classify a first portion of the input file based at least on one or more characteristics of the first portion and an attribute of the first neural network.

18. The system of claim 17, wherein the one or more characteristics of the first portion of the input file and the attribute of the first neural network comprise audio spectrogram features and predicted word error rate (WER) of the first neural network, respectively.

19. The system of claim 18, wherein the audio spectrogram features are extracted from one or more layers of an audio classification neural network.

20. The system of claim 17, wherein the one or more characteristics of the first portion of the input file and the attribute of the first neural network comprise image features and a performance score of the first neural network for the first portion of the input file, respectively.

21. The system of claim 17, wherein the one or more classification objectives comprise a first objective to transcribe audio data of the input file and a second objective to classify one or more objects in video data of the input file.

22. The system of claim 17, wherein the GUI is configured to allow the user to specify a pricing tier of the one or more neural networks to which the classification node can send the one or more portions of the input file for classification.

23. A method for developing a neural network-based application using a visual programming development (VPD) environment, the method comprising:
providing a user interface portal hosted within the VPD environment, the user interface portal comprises:
a data ingestion node configured to ingest and send an input multimedia file to a data preprocessor for preprocessing, wherein the input multimedia file includes audio and video data;
a classification node configured to automatically send the audio data of the input multimedia file to a first group of one or more neural networks for classification and the video data of the input multimedia file to a second group of one or more neural networks for classification; and
an output node configured to receive classification results from the first and second groups of neural networks.
